(19) United States
(12) Patent Application Publication
(10) Pub. No.: US 2020/0334750 A1
(43) Pub. Date: Oct. 22, 2020

(54) TRADER TOOL

(71) Applicant: Wells Fargo Bank, N.A., San Francisco, CA (US)

(72) Inventors: Madeshwaran Mohanraj, Salem (IN); Rameshchandra Bhaskar Ketharaju, Hyderabad (IN); Ram Prasad Jaganathan, Vellore (IN)

(21) Appl. No.: 15/408,789

(22) Filed: Jan. 18, 2017

(51) Int. Cl. G06Q 40/04; G06Q 40/06

(52) U.S. Cl. CPC G06Q 40/04; G06Q 40/06

(57) ABSTRACT

Various examples are directed to systems and methods for trading with a trader device. The trader device may receive a first image captured by an image sensor directed away from a user of the trader device and determine a company indicator depicted in the first image. The trader device may provide, on a display of the trader device, a user interface, based at least in part on first security data describing a first security indicated by the company indicator. The trader device may receive, via the user interface, instruction data describing a trade in the first security. The trader device may receive, from a biometric sensor of the trader device, user biometric data comprising a first value for a first biometric variable of the user, and provide to the user an alert message indicating that the user biometric data is outside of a biometric data range.

### TECHNICAL FIELD

Embodiments described herein generally relate to custom computing devices configured to sense and determine environmental and biometric factors to facilitate device transaction initiation.

### BACKGROUND

Securities trading may be complex. Many institutional and retail traders utilize advanced computer-based trader tools. For example, some trader tools provide traders with securities data describing securities for potential trades. Other trader tools provide traders with the capabilities for making or executing trades. Trader tools, however, are often provided through desktop or laptop computers, which can require traders to sit at a desk or other stationary locations while trading.

### DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings.

FIG. 1 is a diagram showing one example of a system configuration including a trader device.

FIG. 2 is a diagram showing one example of the system configuration of FIG. 1 showing example connections among components.

FIG. 3 is a flowchart showing one example of a process flow that may be executed in the system configuration of FIG. 1 to execute a trade utilizing the trader device.

FIG. 4 is a flowchart showing one example of a process flow that may be executed in the system configuration of FIG. 1 to obtain one or more company identifiers.

FIG. 5 is a flowchart showing one example of a process flow that may be executed in the system configuration of FIG. 1 to perform a biometric trade check.

FIG. 6 is a block diagram showing an example architecture of a mobile computing device.

FIG. 7 is a block diagram showing one example of a software architecture for a computing device.

FIG. 8 is a block diagram illustrating a computing device hardware architecture, within which a set or sequence of instructions can be executed to cause the computing device to perform examples of any one or more of the methodologies discussed herein.

### DETAILED DESCRIPTION

Various examples described herein are directed to custom computing devices configured to provide users, such as securities traders, with environment-based securities data, trade execution, and/or biometric trade validation.

In some examples, a trader computing device, referred to herein as a trader device, may comprise a display and a forward-looking camera, for example, on a side of the device opposite the display. The forward-looking camera may be capable of capturing images that reflect physical objects in the user's environment that are also within a field of view of the camera. The forward-looking camera may be directable by the user. The user may direct the forward-looking camera by moving it to modify the field of view. In some examples, the forward-looking camera may be a component of a mobile phone or other hand-held mobile computing device that is or is in communication with the trader device. The user may direct the field of view of the forward-looking camera by moving the mobile computing device with the user's hand or hands. In another example, the trader device may be or include a wearable device, for example, worn on the user's head. The user may modify the field of view of the forward-looking camera by moving the user's head.

The user may utilize the forward-looking camera to capture an image of the user's environment. The image may depict one or more company indicators. A company indicator may reference one or more companies. For example, a company indicator may include one or more alphanumeric characters that indicate the name of a company, or of a product or service offered by the company. The company indicator, in some examples, may be or include a product offered by the company. The trader device may identify the company indicator and obtain securities data based at least in part on the company indicator. The securities data may describe, for example, equity securities of the indicated company (e.g., stock), debt securities of the indicated company (e.g., bonds), a basket of securities including equity or debt securities of the indicated company, etc. In some examples, the trader device provides the securities data to the user via a user interface. The user interface, in some examples, may also enable the user to execute one or more securities trades, for example, involving securities described by the securities data.

Providing the user with securities data and/or trade execution based on the user's environment may allow the user to engage in securities trading outside of an office or other confined area. For example, the user may visit a shopping mall or other retail location and view products that are selling well or selling poorly. The user may capture an image of a product of interest, which may include a company indicator. Based on the company indicator, the user may view securities data describing securities associated with the company and optionally execute securities trades. In another example, the user may visit a construction site and capture an image of a sign showing the company or companies building at the site. The trader device may provide the user with securities data describing securities associated with the company or companies and allow the user to optionally execute trades in the securities.

In some examples, the user may utilize the trader device to engage in securities trading during non-business hours when the user is performing other daily activities. For example, a trade requested by the user during non-business hours may be executed in markets in other parts of the world that are open when the trade is requested, and/or queued for the next business day. Also, in some examples, the user may utilize the trader device as his or her primary trading environment. This may enable the user to trade with a hands-on perspective of the economy.

In some examples, the trader device is also configured to evaluate user biometric data in conjunction with a trade request. The trader device may comprise one or more biometric sensors to measure biometric variables of the user. Example biometric variables include pupil dilation, skin color, pulse, breathing rate, etc.

When the user requests a trade, the trader device, either alone or in conjunction with a trader server system, may determine if the measured biometric variables indicate that the user's physical state is conducive to trading. For example, the trader device, and/or the trader server system, may determine whether the user's biometric variable or variables are within a biometric data range indicating that the user is in a physical condition conducive to trading. The biometric data range may be based on general biometric data (e.g., applying to many users) or specific biometric data (e.g., applying only to the instant user). In some examples, general biometric data may indicate when all or most users would be in a physical state that is conducive to trading. For example, some or all users with a pulse greater than 120 beats per minute (bpm) may be agitated and may not be in a physical state conducive to trading. Specific biometric data may indicate when the instant user's physical state is or is not conducive to trading. For example, the trader device and/or trader server system may store values for one or more biometric variables of the user when trades are made. This may allow the trader device and/or trader server system to determine biometric variable values that are correlated to successful trades (e.g., profitable or loss-averting trades) as well as biometric variable values that are correlated to unsuccessful trades (e.g., unprofitable or loss-causing trades).

When the user requests a trade, the trader device may alert the user if the user's biometric variable values indicate that the user is not in a physical state that is conducive to trading. For example, processing of the trade request may be interrupted. When the user is alerted that his or her biometric variable values indicate that the user is not in a physical state conducive to trading, the user may choose to cancel the requested trade and/or override the alert and proceed with the trade. In some examples, the trader device and/or trader server system may be programmed to prevent the user from executing a requested trade if the user's biometric variable values indicate that the user is not in a physical state conducive to trading.

User biometric data monitoring, in some examples, may further enable the user to engage in securities trading outside of an office environment. For example, trading outside of an office environment may remove the user from the view and influence of co-workers who might observe the user's physical condition and alert the user if it appears that the user is not in a condition conducive to trading. Biometric data monitoring by the trader device described herein, in some examples, may provide a similar effect.

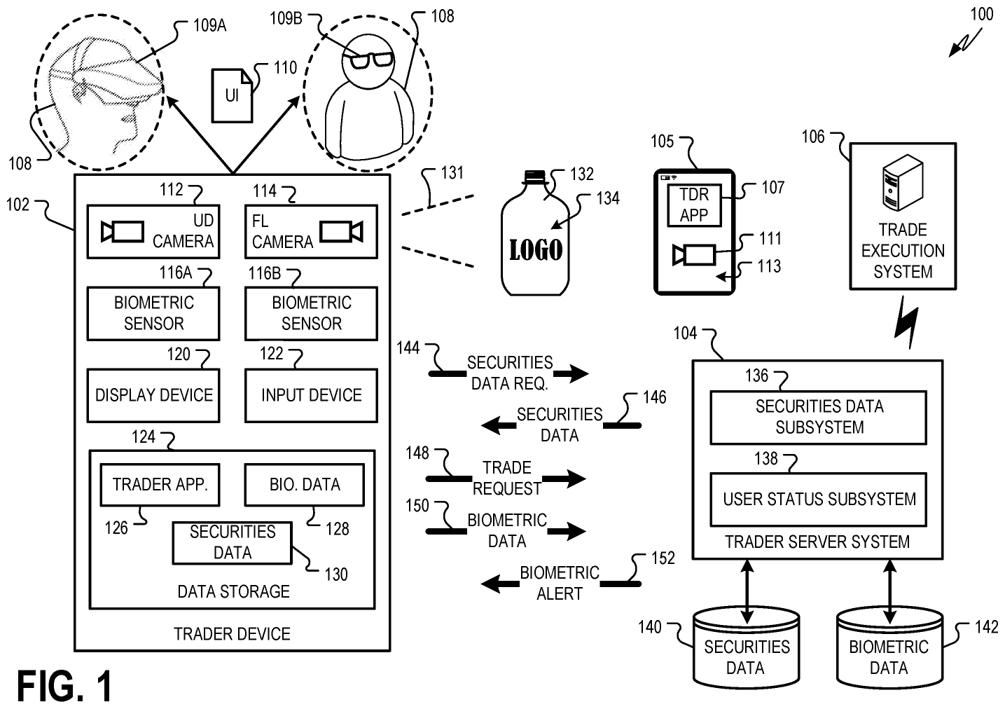

FIG. 1 is a diagram showing one example of a system configuration 100 including a trader device 102. The system configuration 100 also comprises a mobile computing device 105, a trader server system 104, and a trade execution system 106.

The trader device 102 may comprise various sensors including, for example, a forward-looking camera 114, a user-directed camera 112, other biometric sensors 116A, 116B, a display device 120, an input device 122, and a data storage device 124. The forward-looking camera 114 may capture images of a field-of-view 131 visible to the forward-looking camera 114. The forward-looking camera 114 may comprise an image sensor and one or more lenses or other optics to direct light incident from the field-of-view onto the image sensor. When the trader device 102 is in-use, the forward-looking camera 114 may be positioned such that the field-of-view 131 is directed away from a user 108. For example, forward-looking camera 114 may be positioned on one side of the trader device 102 and the display device 120 may be positioned on another side of the trader device 102 opposite the forward-looking camera 114. Also, in some examples, the display device 120 and forward-looking camera 114 may be positioned such that a user 108 viewing the display device 120 would generally not be in the field-of-view 131 of the forward-looking camera 114. In some examples, the forward-looking camera 114 may be positioned such that the field-of-view 131 is aligned with the user's vision.

The user-directed camera 112 and other biometric sensors 116A, 116B may be positioned to sense biometric variables of the user 108. The user-directed camera 112 may also comprise a user-directed image sensor and lenses or other optics to direct light to the image sensor. The user-directed camera 112 may capture one or more images of the user 108. For example, the user-directed camera 112 may capture one or more user images of the user's eyes, which may be used, for example, to determine a dilation of the user's pupils. The user-directed camera 112 may also be used to capture one or more user images of the user's face, which may be used to determine the user's skin color, the shape of various facial features such as cheeks, etc. In some examples, the user-directed camera 112 may also be used as all or a component of an input device. For example, images captured by the user-directed camera 112 may be utilized to determine the direction of the user's eyes.

The other biometric sensors 116A, 116B may be any sensors suitable for measuring biometric variables of the user 108. In some examples, biometric sensors may include, for example, a pressure sensor to determine a pulse of the user 108, a thermometer or other temperature probe for measuring the user's temperature, a pressure sensor for measuring a breath rate of the user 108, etc. In some examples, any sensor that measures biometric variables of the user 108 may be generally referred to as a biometric sensor. This may include the user-directed camera 112 and the other biometric sensors 116A, 116B. Also, as described herein, the user-directed camera 112 may serve as a biometric sensor and may also serve an additional function (e.g., as all or part of the input device 122). Although three biometric sensors 112, 116A, 116B are shown, more or fewer sensors may be included.

The display device 120 may be any suitable display device for providing a user interface 110 to the user 108. For example, the display device 120 may include a Light Emitting Diode (LED) display, a liquid crystal display (LCD), or other suitable hardware. The display device 120 may comprise a single component or, in some examples, may comprise multiple components (e.g., one component for each of the user's eyes). In some examples, the display device 120 is transparent or translucent, allowing the user 108 to see through the display device 120 and to see content displayed at the display device 120.

The input device 122 may be any suitable device for receiving user input, for example, as part of the user interface 110. The input device 122, in some examples, may utilize the user-directed camera 112 or another suitable sensor for determining the eye position of the user 108. For example, the user 108 may manipulate a cursor or other component of the user interface 110 by moving his or her eyes. The input device 122 may be or include any other suitable type of input device, including one or more switches, one or more trackballs, one or more joysticks, etc.

The data storage device 124 may be or include any suitable kind of data storage device, such as a hard drive, a flash drive, etc. The data storage device 124, in some examples, includes code for executing a trader application 126. The trader application 126 may be executed by the trader device 102 to provide and/or facilitate the operations described herein. In some examples, the data storage device 124 may also include historical biometric data 128 captured from the user 108 and/or from another user or users (e.g., from a population of users of the trader device 102 or other, similar trader devices). The data storage device 124, in some examples, also includes securities data 130 describing one or more securities in which the user 108 may trade. In some examples, the biometric data 128 and/or securities data 130 stored at the data storage device 124 may be replaced and/or supplemented by data received from the trader server system 104, as described herein.

FIG. 1 also shows two example frames 109A, 109B that may be used to house the various components of the trader device 102. The example frames 109A, 109B may be worn by the user 108. Accordingly, the trader device 102, in some examples, may be referred to as a wearable device. The example frame 109A is worn over the head of the user 108, covering the user's eyes. The forward-looking camera 114 may capture an image of a portion of the user's environment that would be otherwise visible to the user 108. The image may be displayed on the display device 120. This may allow the user 108 to navigate the user's environment without directly seeing it (e.g., because the example frame 109A is over the user's eyes). For example, the forward-looking camera 114 may be mounted on the example frame 109A with the field-of-view 131 directed away from the user 108's face. The display device 120 may be mounted on the example frame 109A on a side opposite the forward-looking camera 114 such that the display device 120 is visible to the user 108's eyes. The example frame 109B includes one or more transparent display devices 120, allowing the user 108 to view the user's environment directly. In some examples, the example frame 109B may include a display device 120 with a projector that projects content onto the user's retinas, which may also allow the user 108 an unobstructed view of some or all of his or her environment. For example, the forward-looking camera 114 may be mounted on the example frame 109B with the field-of-view 131 directed away from the user 108's face. The display device 120 may be mounted on the example frame 109B on a side opposite the forward-looking camera 114 such that the display device 120 is visible to the user 108's eyes.

The trader device 102 may provide the user 108 with the user interface 110. In some examples, the user interface 110 may include content displayed by the display device 120. This content, in some examples, may be displayed over the user's environment. For example, when the display device 120 is transparent or utilizes a retinal projector, the user 108 may have a clear view of some or all of his or her environment. Content may be displayed on the display device 120 in such a manner as to partially block the user's view. In this way, displayed content may appear to be superimposed on the user's environment. Similarly, when the example frame 109A or display device 120 blocks the user's view of his or her environment, the display device 120 may display content including a representation of the user's environment with content superimposed thereon.

The user interface 110 may also receive input from the user 108. In some examples, the user 108 may direct a cursor or other component of the user interface 110 with the user's eyes. For example, the user-directed camera 112 or another suitable sensor may determine a direction of the user's eyes. In some examples, the user-directed camera 112 or other suitable sensor may also determine when the user 108 “selects” a user interface item with the cursor. For example, the user 108 may select a user interface item by concentrating while the cursor is over the item, which may tend to dilate the user's pupils. The user-directed camera 112 or other suitable sensor may sense such dilation or other indicator and register a selection. For example, the user interface 110 may include user interface items that may be selected to provide additional securities data to the user 108 (e.g., other types of data about the same security, data about a different security, etc.). Also, the user interface 110, in some examples, includes user interface elements that may be selected to request a trade in a security.

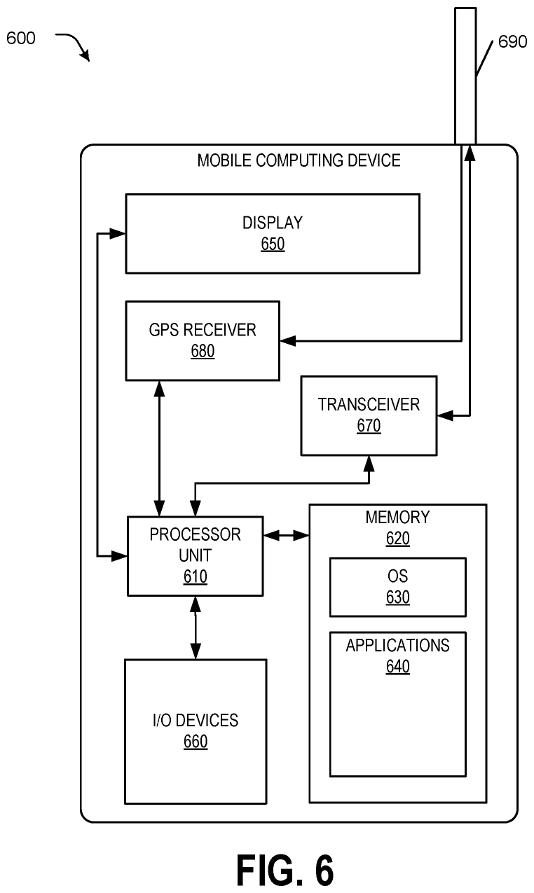

The mobile computing device 105, in some examples, may execute a trader application 107 that may provide some or all of the operations of the trader device 102 described herein (e.g., the operations of the trader application 126). For example, the mobile computing device 105 may be in communication with the trader device 102 via a short-range communication medium such as, for example, Bluetooth®, Near Field Communications (NFC), etc. For example, the trader device 102 may utilize Wi-Fi or other network connectivity components of the mobile computing device 105 to communicate with the trader server system 104 and/or trade execution system 106. Also, in some examples, the trader device 102 may utilize a display or sensors of the mobile computing device 105. For example, a display 113 of the mobile computing device 105 may be used as a replacement for or supplement to the display device 120 of the trader device 102, described herein. Also, in some examples, the user 108 may utilize a camera 111 of the mobile computing device 105 to capture images of company indicators similar to those captured by the forward-looking camera 114. In this way, the camera 111 may supplement or replace the forward-looking camera 114 of the trader device 102. Also, in some examples, various operations and/or functionality of the trader device 102 may be performed by a processor unit (FIG. 6) of the mobile computing device 105.

The trader server system 104 may be or include any suitable type of computing device or devices, such as, for example, one or more servers, at a single geographic location and/or distributed across multiple geographic locations. The trader server system 104 may comprise various subsystems including a securities data subsystem 136 and a user status subsystem 138. The securities data subsystem 136 may be programmed to retrieve and provide securities data to the trader device 102, for example, based on one or more company indicators captured by the forward-looking camera 114 of the trader device 102. For example, the securities data subsystem 136 may be in communication with a securities data source 140 which may include, for example, one or more databases, one or more data feeds, etc.

The user status subsystem 138 may be programmed to perform various operations related to user biometric data monitoring. For example, the user status subsystem 138 may receive biometric data from the trader device 102 and determine whether the biometric data is within a biometric data range and/or whether the biometric data indicates that a user alert should be sent before a requested trade is executed. In other examples, the user status subsystem 138 may provide historical biometric data from a biometric data store 142 to the trader device 102.

In some examples, the trader device 102 and/or trader server system 104 may be in communication with the trade execution system 106. The trade execution system 106 may be or include any suitable type of computing device or devices, such as, for example, one or more servers, at a single geographic location and/or distributed across multiple geographic locations. The trade execution system 106 may receive and execute trade requests. Trade requests provided to the trade execution system 106 may be formatted, in some examples, according to a Financial Information eXchange (FIX) protocol.

In use, the trader device 102 may utilize the forward-looking camera 114 to capture an image of an object or thing in the user 108′s environment. The object or thing may indicate a company. In the example of FIG. 1, an object 132 (in this example, a bottle) is shown in the field-of-view 131 of the forward-looking camera 114. The object 132 includes a logo 134 that maybe alphanumeric and/or symbolic. The trader device 102 (e.g., the trader application 126) may analyze an image of the object 132 and derive a company indicator indicating a company associated with the object. The company indicator may be derived from the shape or size of the object 132. For example, a Coca-Cola® bottle has a distinctive shape that may be recognizable from an image and be directly or indirectly indicative of the Coca-Cola Company. Other objects may also have shapes and/or sizes that indicate the company of origin. For example, a Corvette® car may have a distinctive shape that is directly or indirectly indicative of the General Motors Company.

The company indicator may also be derived from the logo 134. For example, the logo 134 may include one or more symbols that are directly or indirectly indicative of a company. The logo 134 may also include one or more alphanumeric characters that are directly or indirectly indicative of a company. In some examples, the object 132 may be a generic object, such as a billboard, sign, truck, etc., and the logo 134 alone may be indicative of the company. In other examples, both the logo 134 and the object 132 may be indicative of the company. The object 132 and/or logo 134 may be directly indicative of a company, for example, if the object 132 or logo 134 indicates a formal name, trade name, logo, etc., of the company. The object 132 and/or logo 134 may be indirectly indicative of a company, for example, if the object 132 and/or logo 134 indicates a name of a subsidiary of the company, a product or service offered by the company, etc.

The trader device 102 may determine a company indicator, for example, by applying image processing techniques to the image captured by the forward-looking camera 114. For example, the trader device 102 may apply an optical character recognition (OCR) technique to identify alphanumeric characters. Any suitable OCR technique may be used. Also, in some examples, an object recognition technique may be used to recognize a symbolic logo 134 or the object 132. Any suitable object recognition technique may be used.

The trader device 102 may send a securities data request 144 comprising the company indicator data to the trader server system 104 (e.g., the securities data subsystem 136 thereof). The company indicator data included in the securities data request 144 may include a company indicator derived from the image, as described herein. The company indicator may be a company name, a company ticker symbol, etc. The trader server system 104 may send to the trader device 102 securities data 146 describing one or more securities associated with the company indicated by the company indicator. In some examples, the securities data 146 may include scrip data describing the relevant security or securities. Scrip data may include data describing a particular security.

The trader device 102 may provide the securities data 146 to the user 108 via the user interface 110. The user 108, in some examples, decides to request a trade in one or more of the securities indicated by the securities data 146. For example, the trader device 102 may present content to the user 108 describing potential trades via the user interface 110. In some examples, the user 108 may input information describing a requested trade. The trader device 102 may send a trade request 148 to the trader server system 104. Optionally, the trader device 102 may also send biometric data 150 to the trader server system 104. The biometric data 150 may include values for biometric variables of the user 108 measured, for example, by the user-directed camera 112 or another biometric sensor 116A, 116B.

The trader server system 104 may receive the trade request 148 and (optionally) the biometric data 150. The trader server system 104 may determine if the biometric data 150 is outside of a biometric data range, which may, for example, indicate that the user 108's physical state is not conducive to trading. If the biometric data 150 is outside of the biometric data range, the trader server system 104 may send a biometric alert message 152 to the trader device 102. In some examples, the biometric alert message 152 may cause the trader device 102 to pause the execution of the trader application 126 or any other application executing at the trader device 102 and display, at the user interface 110, content indicating the alert. In some examples, the pausing and alert may cancel the requested trade. In other examples, the user 108 may be prompted, via the user interface 110, to either continue or cancel the trade. If the user 108 chooses to continue the trade, this information may be relayed to the trader server system 104, which may send a trade execution message to the trade execution system 106.

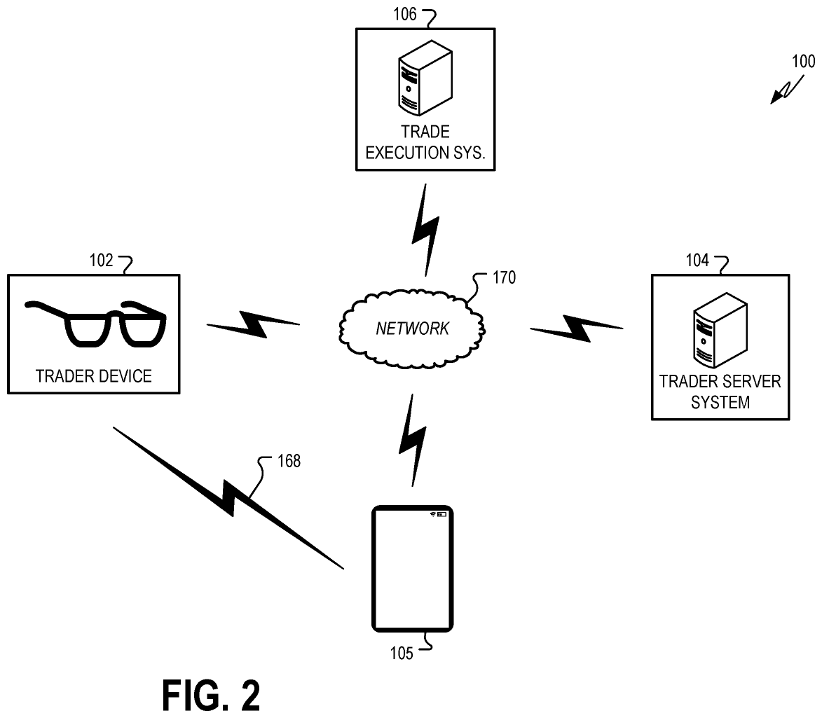

FIG. 2 is a diagram showing one example of the system configuration 100 showing example connections among components. The various components 102, 104, 105, 106 of the system configuration 100 may be in communication with one another via a network 170. The network 170 may be or comprise any suitable network element operated according to any suitable network protocol. For example, one or more portions of the network 170 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, another type of network, or a combination of two or more such networks. In some examples, there is a separate short-range communication medium connection 168 between the trader device 102 and the mobile computing device 105, as described herein.

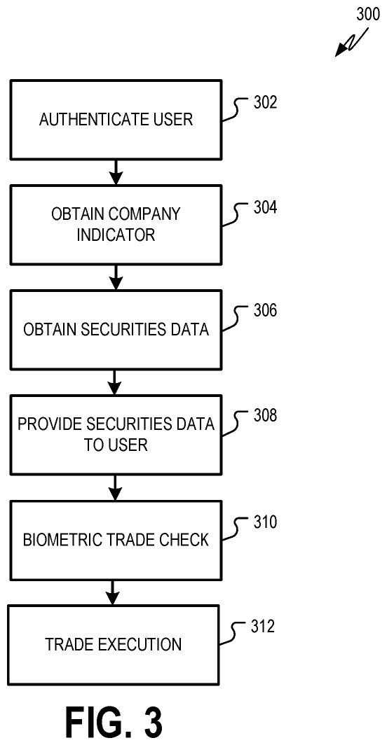

FIG. 3 is a flowchart showing one example of a process flow 300 that may be executed in the system configuration 100 to execute a trade utilizing the trader device 102. At operation 302, the trader device 102 may authenticate the user 108. The trader device 102 may authenticate the user 108 in any suitable manner. For example, the user 108 may provide a username, password, personal identification number (PIN), and/or other identifying information to the trader device 102 via the user interface 110. The trader device 102 may compare the received identifying information to stored identifying information stored either at the trader device 102 and/or at another device, such as the trader server system 104.

Upon authenticating the user 108, the trader device 102 may obtain a company indicator at operation 304. For example, the user 108 may direct the forward-looking camera 114 towards an object, such as the object 132, and may capture an image of the object. The trader device 102 may determine a company indicator from the image and/or may send the image to another component of the system configuration 100, such as the mobile computing device 105, the trader server system 104, etc., which may determine the company indicator from the image.

At operation 306, the trader device 102 may obtain securities data based on the company indicator. The securities data may describe one or more securities associated with the company indicated by the company indicator. For example, the securities data may describe one or more equity securities of the company, one or more debt securities of the company, one or more indices that include the company and/or companies in the same industry, etc. The securities data may be retrieved from various sources, for example, by querying a database, using a lookup table, etc. For example, the securities data may be retrieved from the data storage device 124 of the trader device 102, from a data store of the mobile computing device 105, from the trader server system 104, etc.

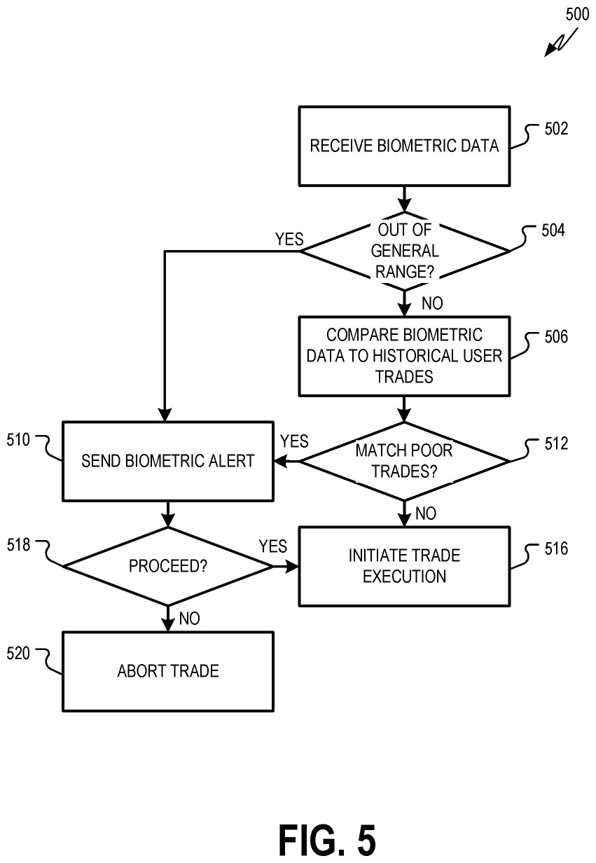

At operation 308, the trader device 102 may provide some or all of the received securities data to the user 108 via the user interface 110. For example, the trader device 102 may generate content including all or part of the securities data and display the content at the display device 120. At operation 310, the trader device 102 may execute a biometric trade check. This may include, for example, capturing biometric data from the user 108 including, for example, values for biometric variables describing the user 108, such as, for example, pulse, breathing rate, skin color, pupil dilation, etc. The trader device 102 may compare the biometric data to a biometric data range. For example, if the biometric data falls within the biometric data range, it may indicate that the user 108's physical condition is conducive to trading. If the biometric data falls outside of the biometric data range, it may indicate that the user 108's physical condition is not conducive to trading. If the biometric data falls outside of the biometric data range, the trader device 102 may provide an alert to the user 108 via the user interface 110. Additional details of the biometric trade check are described herein at FIG. 5.

At operation 312, the trader device 102 may initiate the execution of a trade, for example, at the request of the user 108. For example, the trader device 102 may provide content describing one or more potential trades to the user 108 via the user interface 110 (e.g., based on the received securities data). The user 108 may select a trade to request. In some examples, the biometric trade check at operation 310 may occur after the user 108 requests a trade. A trade request may be sent to the trader server system 104 and/or directly to the trade execution system 106.

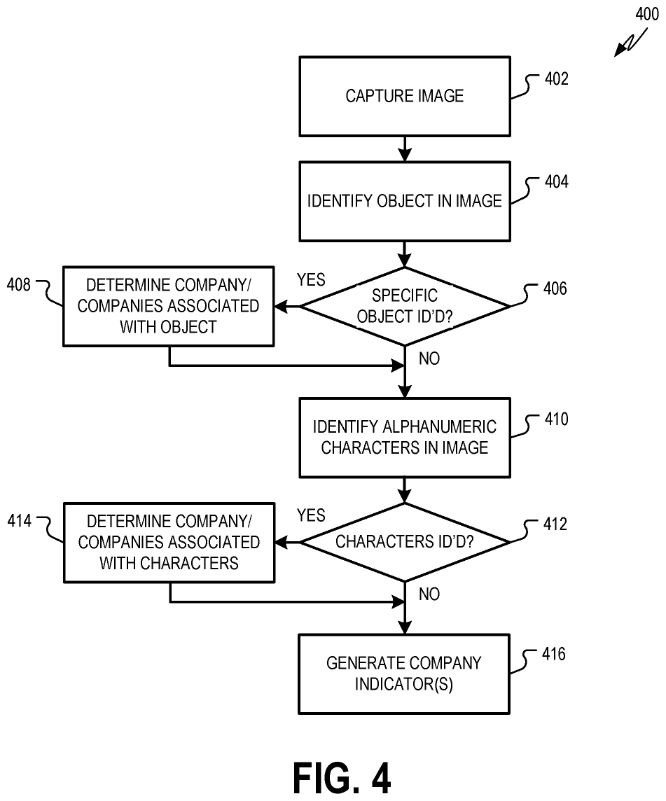

FIG. 4 is a flowchart showing one example of a process flow 400 that may be executed in the system configuration 100 to obtain one or more company identifiers. The process flow 400 shows one example way of obtaining a company indicator at operation 304 of the process flow 300 described above. Referring back to FIG. 4, at operation 402, the trader device 102 may capture an image, for example, with the forward-looking camera 114. The image may depict an object, such as the object 132. In some examples, the image may depict one or more objects. Also, in some examples, the image may be captured by the camera 111 of the mobile computing device 105. At operation 404, the trader device 102 or other suitable component of the system configuration 100 (e.g., the mobile computing device 105, the trader server system 104, etc.) may identify the object in the image. Identifying an object in the image may include applying one or more object recognition techniques to the image. In some examples, the object recognition technique applied at operation 404 may also return non-alphanumeric or stylized alphanumeric logos.

At operation 406, the trader device 102 (or other appropriate device in the system configuration 100) may determine whether a specific object was identified at operation 404. A specific object may be an object that directly or indirectly indicates a company, such as, for example, a car shape, a bottle shape, etc., as described above. If such a specific object was identified, the trader device 102 or other suitable component of the system configuration 100 may, at operation 408, determine a company associated with the identified object. For example, the trader device 102 or other suitable component of the system configuration 100 may compare the detected object with one or more object templates indicating specific objects (e.g., a company insignia, a product shape, etc.).

In some examples, the object identification performed at operation 404 may return a generic object that is not associated with a company, such as a billboard, sign, display, etc. In these cases, the trader device 102 or other suitable component of the system configuration 100 may determine at operation 406 that no specific object was identified. In some examples, an image may include more than one specific object. Accordingly, the trader device 102 or other suitable component of the system configuration 100 may determine multiple companies at operation 408.

If no specific object is determined to have been found at operation 406 or, optionally, from operation 408, the trader device 102 or other suitable component of the system configuration 100 may proceed to operation 410, where the trader device 102 or other suitable component of the system configuration 100 may identify one or more alphanumeric characters in the image. For example, alphanumeric characters may be part of a logo or may otherwise indicate a company or product that may be associated with a company. Any suitable optical character recognition technique may be used.

At operation 412, the trader device 102 or other suitable component of the system configuration 100 may determine if any characters were identified at operation 410. If characters were identified at operation 410, the trader device 102 or other suitable component of the system configuration 100 may determine, at operation 414, a company or companies associated with the characters. For example, the trader device 102 or other suitable component of the system configuration 100 may store a list of strings and companies associated with the strings. If no characters are found at operation 410, or after a company or companies are identified at operation 414, the trader device 102 or other suitable component of the system configuration 100 may generate one or more company indicators at operation 416. In some examples, a company identifier may be generated for each non-duplicative company determined at operation 408 and/or 414. If no objects or characters are determined and/or if the trader device 102 or other suitable component of the system configuration 100 fails to determine a company corresponding to any detected objects or characters, the trader device 102 or other suitable component of the system configuration 100 may return an error.

FIG. 5 is a flowchart showing one example of a process flow 500 that may be executed in the system configuration 100 to perform a biometric trade check. For example, the process flow 500 may be executed by the trader device 102 or other suitable component of the system configuration 100 to execute the operation 310 of the process flow 500. At operation 502, the trader device 102 or other suitable component of the system configuration 100 may receive biometric data. The biometric data may be sensed by one or more of the user-directed camera 112 and/or the other biometric sensors 116A, 116B. For example, the user-directed camera 112 may capture an image of the user 108's eyes that may indicate pupil dilation. The user-directed camera 112 may also capture an image of the user 108's cheeks or other skin area that shows skin color and/or cheek size. In some examples, the user-directed camera 112 may capture an image of the user 108's mouth or other facial features that shows or indicates a facial expression. The other biometric sensors 116A, 116B may indicate an eye direction, a pulse, etc.

Operations 504, 506, and 512 show examples where the trader device 102 or other suitable component of the system configuration 100 determines whether the biometric data received at operation 502 is outside of a biometric data range. For example, these operations show an example where the biometric data is compared to a general range and to a user-specific range. In various embodiments, one or both of these comparisons may be omitted.

In the example of FIG. 5, at operation 504, the trader device 102 or other suitable component of the system configuration 100 may determine if the biometric data received at operation 502 is outside of a general biometric data range. The general biometric data range may be a range of values for biometric data variables that indicate that the user 108 is in a physical state conducive to trading. The general biometric data range may be determined, for example, based on a population of users. For example, the trader server system 104 or other suitable component may monitor trades made by other users. Biometric variable values correlated with successful trades may be within the general biometric data range, while biometric variable values correlated with unsuccessful trades may be outside of the general biometric data range. If the biometric data is outside of the general biometric data range at operation 504, the trader device 102 may send the user 108 a biometric alert at operation 510. In some examples, the general biometric data range may be or include one or more allowable ranges for individual biometric variable values. For example, if the user's pulse is above 120 bpm, the user biometric data may be outside of the general biometric data range. Similar allowable ranges may be set for other biometric variables.

If the biometric data is not outside of the general biometric data range at operation 504, then at operation 506, the trader device 102 or other suitable component of the system configuration 100 may compare the biometric data to user historical trade data describing historical trades of the user 108 (e.g., previous trades that the user 108 has made). For example, the trader device 102 or other suitable component of the system configuration 100 may select a set of historical trades by the user 108 that are rated as successful (e.g., profitable, loss-averting trades) and compare the biometric data to user historical biometric data describing the user 108 when the successful trades were made. Similarly, the trader device 102 or other suitable component of the system configuration 100 may select a set of historical trades by the user 108 that are rated as unsuccessful (e.g., unprofitable or loss-causing trades) and compare the biometric data to user historical biometric data describing the user 108 when the unsuccessful trades were made. If, at operation 512, it is determined that the biometric data does not correlate to unsuccessful trades previously made by the user 108, the trader device 102 or other suitable component of the system configuration 100 may initiate execution of the requested trade at operation 516 (e.g., by requesting the trade from the trader server system 104 and/or the trade execution system 106). If the biometric data does correlate to unsuccessful trades at operation 512, the trader device 102 or other suitable component of the system configuration 100 may send the user 108 a biometric alert at operation 510.

The biometric alert provided to the user 108 at operation 510 may be provided in any suitable manner. In some examples, the trader device 102 may receive the biometric alert from the trader server system 104. The alert may be included in a message that also includes an interrupt or other data that prompts the trader device 102 to pause the execution of its current operation and proceed to a portion of the trader application 126 code that provides the alert. The trader device 102 may incorporate an indication of the alert into the user interface 110, for example, in a manner intended to draw attention to the alert. For example, the alert may flash or be rendered in an easily noticeable color such as red, neon, etc.

At operation 518, the trader device 102 may prompt the user 108 to either proceed with the requested trade despite the biometric alert or to abort the trade. For example, the trader device 102 may render two buttons or other indicators at the user interface 110. The user 108 may select a first button to proceed with the trade and a second button to abort the trade. If the user 108 chooses to proceed with the trade, the trader device 102 or other suitable component of the system configuration 100 may initiate execution of the trade at operation 516. If the user 108 chooses to abort the trade, the trader device 102 or other suitable component of the system configuration 100 may abort the trade at operation 520. For example, the trader device 102 may decline to send a trade authorization to the trader server system 104 and/or send the trader server system 104 an explicit message indicating that the trade is aborted.

FIG. 6 is a block diagram showing an example architecture 600 of a mobile computing device. For example, the architecture 600 may describe the trader device 102 and/or the mobile computing device 105. The architecture 600 comprises a processor unit 610. The processor unit 610 may include one or more processors. Any of a variety of different types of commercially available processors suitable for mobile computing devices may be used (for example, an XScale architecture microprocessor, a Microprocessor without Interlocked Pipeline Stages (MIPS) architecture processor, or another type of processor). A memory 620, such as a Random Access Memory (RAM), a flash memory, or another type of memory or data storage, is typically accessible to the processor unit 610. The memory 620 may be adapted to store an operating system (OS) 630, as well as application programs 640. In some examples, the OS 630 may implement software interrupts that cause the architecture 600 to pause its current task and execute an interrupt service routine (ISR) when an interrupt is received. For example, when an alert message is pushed to a computing device arranged according to the architecture 600, it may include or trigger a software interrupt. The ISR for the software interrupt may launch the appropriate user interface (e.g., user interface 110) and display the received alert message.

The processor unit 610 may be coupled, either directly or via appropriate intermediary hardware, to a display 650 and to one or more input/output (I/O) devices 660, such as a keypad, a touch panel sensor, a microphone, and the like. Such I/O devices 660 may include a touch sensor for capturing fingerprint data, a camera for capturing one or more images of a user, a retinal scanner, or any other suitable devices. Similarly, in some examples, the processor unit 610 may be coupled to a transceiver 670 that interfaces with an antenna 690. The transceiver 670 may be configured to both transmit and receive cellular network signals, wireless data signals, or other types of signals via the antenna 690, depending on the nature of the mobile computing device implemented by the architecture 600. Although one transceiver 670 is shown, in some examples, the architecture 600 includes additional transceivers. For example, a wireless transceiver may be utilized to communicate according to an IEEE 802.11 specification, such as Wi-Fi, and/or to a short-range communication medium. Some short-range communication mediums, such as NFC, may utilize a separate, dedicated transceiver. Further, in some configurations, a GPS receiver 680 may also make use of the antenna 690 to receive GPS signals. In some examples, the architecture 600 (e.g., processor unit 610) may also support a hardware interrupt. In response to a hardware interrupt, the processor unit 610 may pause its processing and execute an ISR. For example, an alert message may include and/or trigger a hardware interrupt. The ISR for the hardware interrupt may launch the appropriate user interface (e.g., user interface 110) and display the received alert message.

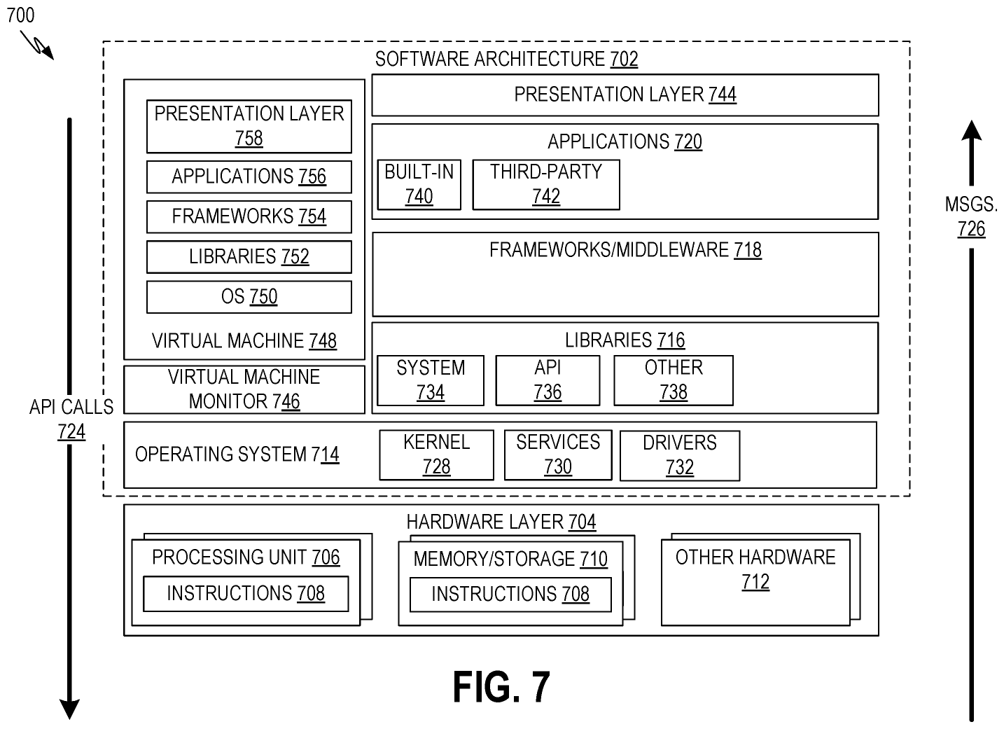

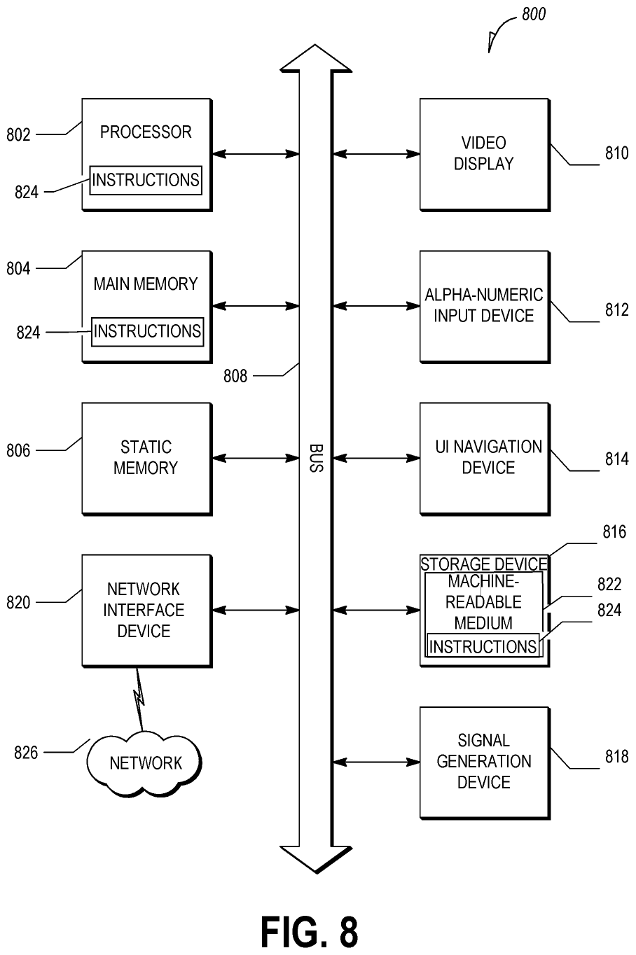

FIG. 7 is a block diagram 700 showing one example of a software architecture 702 for a computing device, such as the trader device 102, the mobile computing device 105, and/or any servers or other computing devices of the trader server system 104 or trade execution system 106. The software architecture 702 may be used in conjunction with various hardware architectures, for example, as described herein. FIG. 7 is merely a non-limiting example of a software architecture, and many other architectures may be implemented to facilitate the functionality described herein. The software architecture 702 may be executed on hardware such as, for example, the trader device 102, the trader server system 104, the trade execution system 106, etc. A representative hardware layer 704 is illustrated and can represent, for example, any of the above-referenced computing devices. In some examples, the hardware layer 704 may be implemented according to the architecture 600 of FIG. 6 and/or an architecture 800 described with respect to FIG. 8.

The representative hardware layer 704 comprises one or more processing units 706 having associated executable instructions 708. The executable instructions 708 represent the executable instructions of the software architecture 702, including implementation of the methods, modules, subsystems, components, and so forth of FIGS. 1-5. The hardware layer 704 also includes memory and/or storage modules 710, which also have the executable instructions 708. The hardware layer 704 may also comprise other hardware 712, which represents any other hardware of the hardware layer 704, such as the other hardware illustrated as part of the hardware architecture 800.

In the example architecture of FIG. 7, the software architecture 702 may be conceptualized as a stack of layers where each layer provides particular functionality. For example, the software architecture 702 may include layers such as an operating system 714, libraries 716, frameworks/middleware 718, applications 720, and a presentation layer 744. Operationally, the applications 720 and/or other components within the layers may invoke application programming interface (API) calls 724 through the software stack and receive a response, returned values, and so forth illustrated as messages 726 in response to the API calls 724. The layers illustrated are representative in nature, and not all software architectures have all layers. For example, some mobile or special-purpose operating systems may not provide a frameworks/middleware 718 layer, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. In some examples, the services 730 include an interrupt service. The interrupt service may detect the receipt of an interrupt and, in response, cause the software architecture 702 to pause its current processing and execute an ISR when the interrupt is received. For example, when an alert message is pushed to a computing device arranged according to the software architecture 702, it may include or trigger an interrupt. The interrupt service may cause the software architecture 702 to execute an ISR that launches the appropriate user interface (e.g., user interface 110) and displays the received alert message.

The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 716 may provide a common infrastructure that may be utilized by the applications 720 and/or other components and/or layers. The libraries 716 typically provide functionality that allows other software modules to perform tasks in an easier fashion than by interfacing directly with the underlying operating system 714 functionality (e.g., kernel 728, services 730, and/or drivers 732). The libraries 716 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks 718 (also sometimes referred to as middleware) may provide a higher-level common infrastructure that may be utilized by the applications 720 and/or other software components/modules. For example, the frameworks 718 may provide various graphic user interface (GUI) functions, high-level resource management, high-level location services, and so forth. The frameworks 718 may provide a broad spectrum of other APIs that may be utilized by the applications 720 and/or other software components/modules, some of which may be specific to a particular operating system or platform.

The applications 720 include built-in applications 740 and/or third-party applications 742. Examples of representative built-in applications 740 may include, but are not limited to, a contacts application, a browser application, a book reader application, a location application, a media application, a messaging application, and/or a game application. The third-party applications 742 may include any of the built-in applications as well as a broad assortment of other applications. In a specific example, the third-party application 742 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 742 may invoke the API calls 724 provided by the mobile operating system such as the operating system 714 to facilitate functionality described herein.

The applications 720 may utilize built-in operating system functions (e.g., kernel 728, services 730, and/or drivers 732), libraries (e.g., system libraries 734, API libraries 736, and other libraries 738), or frameworks/middleware 718 to create user interfaces to interact with users of the system. Alternatively, or additionally, in some systems interactions with a user may occur through a presentation layer, such as the presentation layer 744. In these systems, the application/module “logic” can be separated from the aspects of the application/module that interact with a user.

Some software architectures utilize virtual machines. For example, the trader server system 104 and/or some or all of the subsystems 136, 138 thereof may be executed on one or more virtual machines executed at one or more server computing machines. In the example of FIG. 7, this is illustrated by a virtual machine 748. A virtual machine creates a software environment where applications/modules can execute as if they were executing on a hardware computing device. A virtual machine is hosted by a host operating system (operating system 714) and typically, although not always, has a virtual machine monitor 746, which manages the operation of the virtual machine as well as the interface with the host operating system (i.e., operating system 714). A software architecture executes within the virtual machine, such as an operating system 750, libraries 752, frameworks/middleware 754, applications 756, and/or a presentation layer 758. These layers of software architecture executing within the virtual machine 748 can be the same as corresponding layers previously described or may be different.

FIG. 8 is a block diagram illustrating a computing device hardware architecture 800, within which a set or sequence of instructions can be executed to cause the computing device to perform examples of any one or more of the methodologies discussed herein. For example, the architecture 800 may execute the software architecture 702 described with respect to FIG. 7. The architecture 800 may operate as a standalone device or may be connected (e.g., networked) to other machines. In a networked deployment, the architecture 800 may operate in the capacity of either a server or a client machine in server-client network environments, or it may act as a peer machine in peer-to-peer (or distributed) network environments. The architecture 800 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify actions to be taken by that machine. The architecture 800 may describe a hardware configuration of, for example, the trader device 102, the mobile computing device 105, and/or any servers or other computing devices of the trader server system 104 or trade execution system 106.

Example architecture 800 includes a processor unit 802 comprising at least one processor (e.g., a central processing unit (CPU), a graphics processing unit (GPU), both a CPU and a GPU, processor cores, compute nodes, etc.). The architecture 800 may further comprise a main memory 804 and a static memory 806, which communicate with each other via a link 808 (e.g., bus). The architecture 800 can further include a video display unit 810, an alphanumeric input device 812 (e.g., a keyboard), and a user interface (UI) navigation device 814 (e.g., a mouse). In some examples, the video display unit 810, alphanumeric input device 812, and UI navigation device 814 are incorporated into a touch screen display. The architecture 800 may additionally include a storage device 816 (e.g., a drive unit), a signal generation device 818 (e.g., a speaker), a network interface device 820, and one or more sensors (not shown), such as a global positioning system (GPS) sensor, compass, accelerometer, or other sensor.

In some examples, the processor unit 802 or another suitable hardware component may support a hardware interrupt. In response to a hardware interrupt, the processor unit 802 may pause its processing and execute an ISR. For example, an alert message may include and/or trigger a hardware interrupt. The ISR for the hardware interrupt may launch or modify the appropriate user interface (e.g., the user interface 110) and display the received alert message.

The storage device 816 includes a machine-readable medium 822 on which is stored one or more sets of data structures and instructions 824 (e.g., software) embodying or utilized by any one or more of the methodologies or functions described herein. The instructions 824 can also reside, completely or at least partially, within the main memory 804, within the static memory 806, and/or within the processor unit 802 during execution thereof by the architecture 800, with the main memory 804, the static memory 806, and the processor unit 802 also constituting machine-readable media. The instructions 824 stored at the machine-readable medium 822 may include, for example, instructions for implementing the software architecture 702, instructions for executing any of the features described herein, etc.

While the machine-readable medium 822 is illustrated in an example to be a single medium, the term “machine-readable medium” can include a single medium or multiple media (e.g., a centralized or distributed database, and/or associated caches and servers) that store the one or more instructions 824. The term “machine-readable medium” shall also be taken to include any tangible medium that is capable of storing, encoding, or carrying instructions for execution by the machine and that cause the machine to perform any one or more of the methodologies of the present disclosure, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 can further be transmitted or received over a communications network 826 using a transmission medium via the network interface device 820 utilizing any one of a number of well-known transfer protocols (e.g., HTTP). Examples of communication networks include a LAN, a WAN, the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible media to facilitate communication of such software.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

1. An automated trader device to facilitate securities trading outside of an office environment, the automated trader device comprising:
a frame configured to be positioned over at least a portion of a face of a user;
an image sensor coupled to the frame, the image sensor having an image sensor field-of-view that is directed away from the user;
a biometric sensor coupled to the frame, the biometric sensor to measure a first biometric variable of the user;
a display coupled to the frame; and
a processor unit in communication with the image sensor, the biometric sensor, and the display, wherein the processor unit is programmed to perform operations comprising:
receiving a first image captured by the image sensor;
determining a company indicator depicted in the first image, wherein the company indicator indicates a first company;
sending, to a trader server, a securities data request comprising the company indicator;
receiving, from the trader server, first security data describing a first security indicated by the company indicator;
receiving, via a user interface provided at least in part via the display, instruction data describing a trade in the first security;
receiving, from the biometric sensor, user biometric data comprising a first value for the first biometric variable;
retrieving user historical trade data describing a plurality of historical trades made by the user;
selecting from the plurality of historical trades a set of unsuccessful historical trades;
retrieving user historical biometric data describing values for the first biometric variable for the user during at least a portion of the set of unsuccessful historical trades;
determining that the user biometric data is outside of a biometric data range, the biometric data range based at least in part on the values for the first biometric variable for the user during the at least a portion of the set of unsuccessful historical trades; and
providing to the user an alert message indicating that the user biometric data is outside of the biometric data range, the alert message provided via the display coupled to the frame.

2. (canceled)

3. The trader device of claim 1, wherein the biometric sensor comprises a user-directed image sensor with a field-of-view to be directed towards the user, and wherein the processor unit is further programmed to perform operations comprising:
receiving a first user image captured by the user-directed image sensor, wherein the first user image depicts at least a portion of the user; and
determining, the first value for the first biometric variable based at least in part on the first user image.

4. The trader device of claim 3, wherein the first biometric variable is at least one of a skin color of the user and a pupil dilation of the user.

5. The trader device of claim 1, wherein the processor unit is further programmed to perform operations comprising determining that the first value for the first biometric variable is outside an allowable range for the first biometric variable.

6. (canceled)

7. The trader device of claim 1, wherein the first biometric variable is a pulse of the user.

8. The trader device of claim 1, wherein the processor unit is further programmed to perform operations comprising:
after providing the alert message to the user, receiving from the user an indication to proceed with the trade; and
initiating execution of the trade in the first security.

9. The trader device of claim 1, wherein the processor unit is further programmed to perform operations comprising:
identifying at least one alphanumeric character depicted in the first image; and
determining that the at least one alphanumeric character is associated with the first company.

10. The trader device of claim 1, wherein the processor unit is further programmed to perform operations comprising:
identifying a first object depicted in the first image; and
determining that the first object is associated with the first company.

11. A method for automated trading outside of an office environment using a trader device, comprising:
receiving, by the trader device, a first image captured by an image sensor, the image sensor coupled to a frame that is positioned over at least a portion of a face of a user, the image sensor having an image sensor field-of-view that is directed away from the user of the trader device;
determining a company indicator depicted in the first image, wherein the company indicator indicates a first company;
sending, by the trader device, a securities data request comprising the company indicator;
receiving, by the trader device, first security data describing a first security indicated by the company indicator;
receiving, by the trader device and via a user interface, instruction data describing a trade in the first security;
receiving, from a biometric sensor of the trader device, user biometric data comprising a first value for a first biometric variable of the user;
retrieving user historical trade data describing a plurality of historical trades made by the user;
selecting from the plurality of historical trades a set of unsuccessful historical trades;
retrieving user historical biometric data describing values for the first biometric variable for the user during at least a portion of the set of unsuccessful historical trades;
determining that the user biometric data is outside of a biometric data range, the biometric data range based at least in part on the values for the first biometric variable for the user during the at least a portion of the set of unsuccessful historical trades; and
providing to the user an alert message indicating that the user biometric data is outside of biometric data range, the alert message provided via a display coupled to the frame.

12. (canceled)

13. The method of claim 11, wherein the biometric sensor comprises a user-directed image sensor with a field-of-view to be directed towards the user, and further comprising:
receiving a first user image captured by the user-directed image sensor, wherein the first user image depicts at least a portion of the user; and
determining the first value for the first biometric variable based at least in part on the first user image.

14. The method of claim 13, wherein the first biometric variable is at least one of a skin color of the user and a pupil dilation of the user.

15. The method of claim 11, further comprising determining that the first value for the first biometric variable is outside an allowable range for the first biometric variable.

16. (canceled)

17. The method of claim 11, wherein the first biometric variable is a pulse of the user.

18. The method of claim 11, further comprising:
after providing the alert message to the user, receiving from the user an indication to proceed with the trade; and
initiating execution of the trade in the first security.

19. The method of claim 11, further comprising:
identifying at least one alphanumeric character depicted in the first image; and
determining that the at least one alphanumeric character is associated with the first company.

20. The method of claim 11, further comprising:
identifying a first object depicted in the first image; and
determining that the first object is associated with the first company.

21. A machine-readable medium comprising instructions thereon that, when executed by a processor unit_{;} cause the processor unit to perform operations comprising:
receiving, by a trader device, a first image captured by an image sensor, the image sensor coupled to a frame that is positioned over at least a portion of a face of a user, the image sensor having an image sensor field-of-view directed away from the user of the trader device, the trader device configured to facilitate securities trading outside of an office environment;
determining a company indicator depicted in the first image;
sending, by the trader device, a securities data request comprising the company indicator;
receiving, by the trader device, first security data describing a first security indicated by the company indicator;
providing, to a display of the trader device, a user interface, based at least in part on the first security data;
receiving, by the trader device and via the user interface, instruction data describing a trade in the first security;
receiving, from a biometric sensor of the trader device, user biometric data comprising a first value for a first biometric variable of the user;
retrieving user historical trade data describing a plurality of historical trades made by the user;
selecting from the plurality of historical trades a set of unsuccessful historical trades;
retrieving user historical biometric data describing values for the first biometric variable for the user during at least a portion of the set of unsuccessful historical trades;
determining that the user biometric data is outside of a biometric data range, the biometric data range based at least in part on the values for the first biometric variable for the user during the at least a portion of the set of unsuccessful historical trades; and
providing to the user an alert message indicating that the user biometric data is outside of a biometric data range, the alert message provided via a display coupled to the frame.

22. The medium of claim 21, wherein the biometric sensor comprises a user-directed image sensor with a field-of-view to be directed towards the user, and the operations further comprising:
receiving a first user image captured by the user-directed image sensor, wherein the first user image depicts at least a portion of the user; and
determining the first value for the first biometric variable based at least in part on the first user image.

23. The medium of claim 22, wherein the first biometric variable is at least one of a skin color of the user or a pupil dilation of the user.

24. The medium of claim 21, the operations further comprising determining that the first value for the first biometric variable is outside an allowable range for the first biometric variable.

25. The medium of claim 21, wherein the first biometric variable is a pulse of the user.
